(19) United States
(12) Patent Application Publication
(10) Pub. No.: US 2026/0094770 A1
(43) Pub. Date: Apr. 2, 2026

(54) CAPACITOR STRUCTURE AND METHOD FOR FABRICATING THE SAME

(71) Applicant: NANYA TECHNOLOGY CORPORATION, NEW TAIPEI CITY (TW)

(72) Inventor: WEI-CHUAN FANG, NEW TAIPEI CITY (TW)

(21) Appl. No.: 18/903,246

(22) Filed: Oct. 1, 2024

(51) Int. Cl. H01G 11/04; H01G 11/28; H01G 11/36; H01G 11/46; H01G 11/52; H01G 11/70

(52) U.S. Cl. CPC H01G 11/04; H01G 11/28; H01G 11/36; H01G 11/46; H01G 11/52; H01G 11/70

(57) ABSTRACT

The present application discloses a capacitor structure and a method for fabricating the capacitor structure. The capacitor structure includes a first electrode including carbon nanotubes; a second electrode including graphene and vanadium oxide; a separator separating the first electrode and the second electrode; and a first type electrolyte surrounding the first electrode, the second electrode, and the separator.

### TECHNICAL FIELD

The present disclosure relates to a capacitor structure and a method for fabricating the capacitor structure, and more particularly, to an asymmetric supercapacitor and the method for fabricating the asymmetric supercapacitor.

### DISCUSSION OF THE BACKGROUND

Traditional capacitors, while useful for a variety of applications, fall short in meeting the demands of fields like electric vehicles (EVs) and renewable energy systems. These capacitors typically have low energy density, meaning they can store only a limited amount of energy compared to their weight and size, which is a critical limitation for applications that require rapid energy storage and discharge. In electric vehicles, for instance, traditional capacitors cannot provide the high power output needed for quick acceleration or manage regenerative braking efficiently. Additionally, their lifespan and charge-discharge cycles are limited, making them less suitable for applications requiring durability and reliability. As the push for more efficient and sustainable energy solutions grows, there is an increasing demand for supercapacitors, which offer significantly higher energy and power densities, faster charging times, and longer cycle life. These characteristics make supercapacitors an ideal choice for integrating with traditional battery systems, enhancing performance and extending the operational capabilities of modern electric vehicles and other energy-intensive applications.

This Discussion of the Background section is provided for background information only. The statements in this Discussion of the Background are not an admission that the subject matter disclosed in this section constitutes prior art to the present disclosure, and no part of this Discussion of the Background section may be used as an admission that any part of this application, including this Discussion of the Background section, constitutes prior art to the present disclosure.

### SUMMARY

One aspect of the present disclosure provides a capacitor structure including a first electrode including carbon nanotubes; a second electrode including graphene and vanadium oxide; a separator separating the first electrode and the second electrode; and a first type electrolyte surrounding the first electrode, the second electrode, and the separator.

Another aspect of the present disclosure provides a capacitor structure including a first electrode including carbon nanotubes; a second electrode including graphene and vanadium oxide; and a second type electrolyte positioned between the first electrode and the second electrode; wherein the second type electrolyte is a solid-state electrolyte. Both the first electrode and the second electrode contact the second type electrolyte.

Another aspect of the present disclosure provides a method for fabricating a capacitor structure including forming a first electrode on the first conductive collector; forming a second electrode on the second conductive collector; and encapsulating the first electrode, the first conductive collector, the second electrode, and the second conductive collector in a case along with a separator separating the first electrode and the second electrode, and a first type electrolyte filling the case; wherein the first electrode includes carbon nanotubes. The second electrode includes graphene and vanadium oxide.

Due to the design of the capacitor structure of the present disclosure, dispersion may become more uniform, and charge transfer may be enhanced by using carbon nanotubes for the first electrode. Additionally, the graphene in the second electrode may provide a larger surface area for distributing vanadium oxide, further increasing the conductivity of the second electrode. Consequently, the overall performance of the capacitor structure may improve. Furthermore, employing the second type electrolyte may enhance the safety, mechanical stability, and operating voltage window of the capacitor structure, while also reducing self-discharge.

The foregoing has outlined rather broadly the features and technical advantages of the present disclosure in order that the detailed description of the disclosure that follows may be better understood. Additional features and advantages of the disclosure will be described hereinafter and form the subject of the claims of the disclosure. It should be appreciated by those skilled in the art that the conception and specific embodiment disclosed may be readily utilized as a basis for modifying or designing other structures or processes for carrying out the same purposes of the present disclosure. It should also be realized by those skilled in the art that such equivalent constructions do not depart from the spirit and scope of the disclosure as set forth in the appended claims.

### BRIEF DESCRIPTION OF THE DRAWINGS

Aspects of the present disclosure are best understood from the following detailed description when read with the accompanying figures. It should be noted that, in accordance with the standard practice in the industry, various features are not drawn to scale. In fact, the dimensions of the various features may be arbitrarily increased or reduced for clarity of discussion.

FIG. 1 illustrates, in a schematic cross-sectional view diagram, a capacitor structure in accordance with one embodiment of the present disclosure;

FIG. 2 illustrates a graphene ribbon according to one embodiment of the present disclosure;

FIG. 3 illustrates a cylindrical graphene ribbon according to one embodiment of the present disclosure;

FIG. 4 illustrates cross-sections of multi-walled carbon nanotubes according to some embodiments of the present disclosure;

FIG. 5 illustrates, in a schematic cross-sectional view diagram, a capacitor structure in accordance with another embodiment of the present disclosure; and

FIG. 6 illustrates, in a flowchart diagram form, a method for fabricating a capacitor structure in accordance with one embodiment of the present disclosure.

### DETAILED DESCRIPTION

The following disclosure provides many different embodiments, or examples, for implementing different features of the provided subject matter. Specific examples of components and arrangements are described below to simplify the present disclosure. These are, of course, merely examples and are not intended to be limiting. For example, the formation of a first feature over or on a second feature in the description that follows may include embodiments in which the first and second features are formed in direct contact, and may also include embodiments in which additional features may be formed between the first and second features, such that the first and second features may not be in direct contact. In addition, the present disclosure may repeat reference numerals and/or letters in the various examples. This repetition is for the purpose of simplicity and clarity and does not in itself dictate a relationship between the various embodiments and/or configurations discussed.

Further, spatially relative terms, such as “beneath,” “below,” “lower,” “above,” “upper” and the like, may be used herein for ease of description to describe one element or feature's relationship to another element(s) or feature(s) as illustrated in the figures. The spatially relative terms are intended to encompass different orientations of the device in use or operation in addition to the orientation depicted in the figures. The apparatus may be otherwise oriented (rotated 90 degrees or at other orientations) and the spatially relative descriptors used herein may likewise be interpreted accordingly.

It should be understood that when an element or layer is referred to as being “connected to” or “coupled to” another element or layer, it can be directly connected to or coupled to another element or layer, or intervening elements or layers may be present.

It should be understood that, although the terms first, second, etc. may be used herein to describe various elements, these elements should not be limited by these terms. Unless indicated otherwise, these terms are only used to distinguish one element from another element. Thus, for example, a first element, a first component or a first section discussed below could be termed a second element, a second component or a second section without departing from the teachings of the present disclosure.

Unless the context indicates otherwise, terms such as “same,” “equal,” “planar,” or “coplanar,” as used herein when referring to orientation, layout, location, shapes, sizes, amounts, or other measures do not necessarily mean an exactly identical orientation, layout, location, shape, size, amount, or other measure, but are intended to encompass nearly identical orientation, layout, location, shapes, sizes, amounts, or other measures within acceptable variations that may occur, for example, due to manufacturing processes. The term “substantially” may be used herein to reflect this meaning. For example, items described as “substantially the same,” “substantially equal,” or “substantially planar,” may be exactly the same, equal, or planar, or may be the same, equal, or planar within acceptable variations that may occur, for example, due to manufacturing processes.

It should be noted that, in the description of the present disclosure, above (or up) corresponds to the direction of the arrow of the direction Z, and below (or down) corresponds to the opposite direction of the arrow of the direction Z.

It should be noted that, the term “about” modifying the quantity of an ingredient, component, or reactant of the present disclosure employed refers to variation in the numerical quantity that can occur, for example, through typical measuring and liquid handling procedures used for making concentrates or solutions. Furthermore, variation can occur from inadvertent error in measuring procedures, differences in the manufacture, source, or purity of the ingredients employed to make the compositions or carry out the methods, and the like. In one aspect, the term “about” means within 10% of the reported numerical value. In another aspect, the term “about” means within 5% of the reported numerical value. Yet, in another aspect, the term “about” means within 10, 9, 8, 7, 6, 5, 4, 3, 2, or 1% of the reported numerical value.

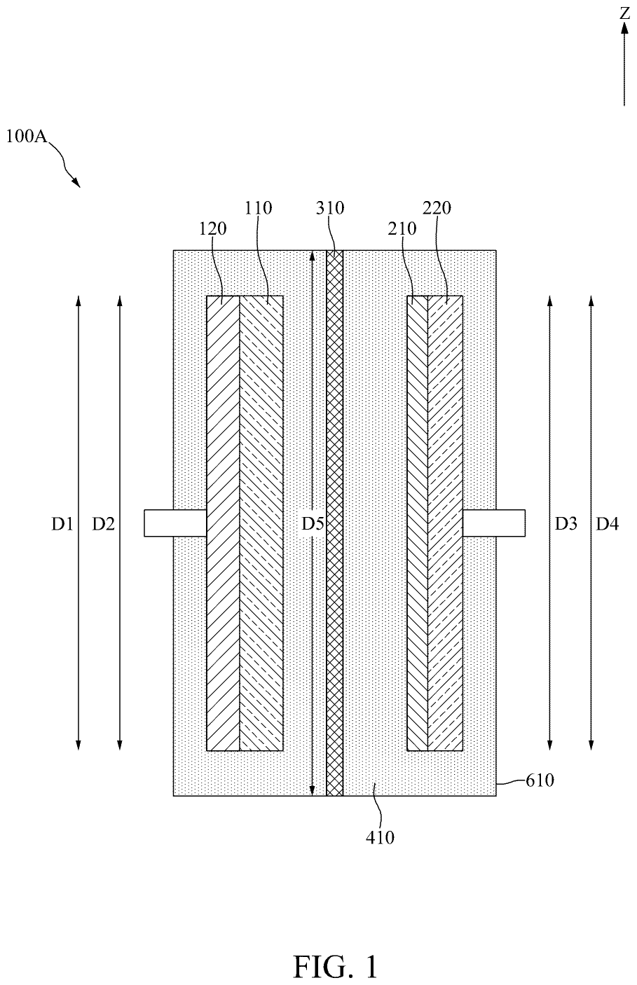

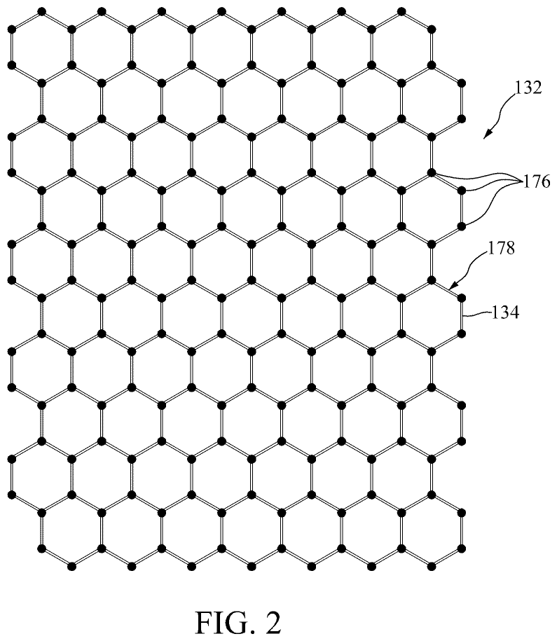

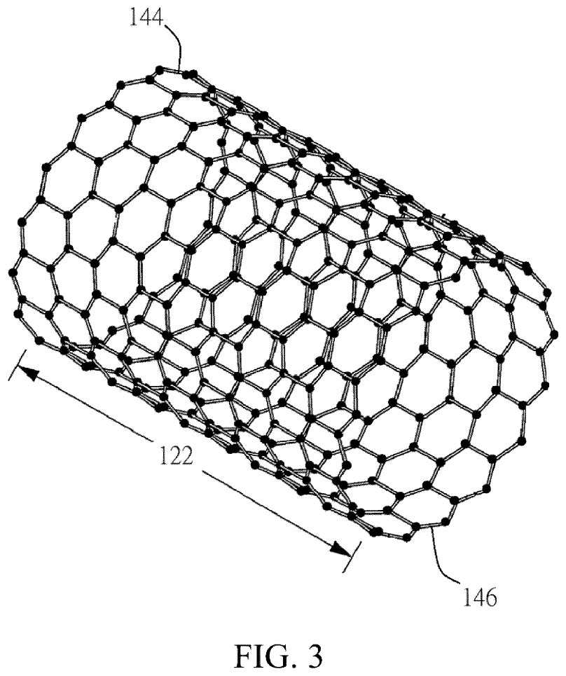

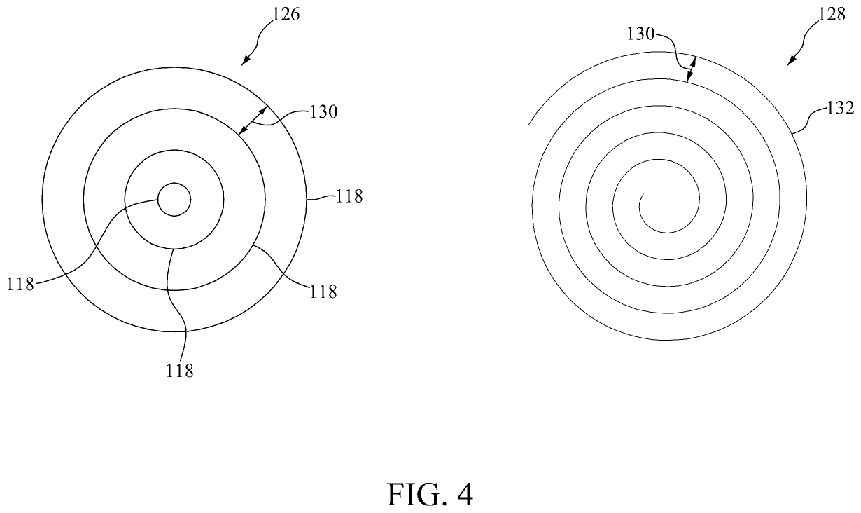

FIG. 1 illustrates, in a schematic cross-sectional view diagram, a capacitor structure 100A in accordance with one embodiment of the present disclosure. FIG. 2 illustrates a graphene ribbon according to one embodiment of the present disclosure. FIG. 3 illustrates a cylindrical graphene ribbon according to one embodiment of the present disclosure. FIG. 4 illustrates cross-sections of multi-walled carbon nanotubes according to some embodiments of the present disclosure.

With reference to FIG. 1, the capacitor structure 100A may include a first electrode 110, a second electrode 210, a first conductive collector 120, a second conductive collector 220, a separator 310, a first type electrolyte 410, and a case 610. The first electrode 110 may be disposed on the first conductive collector 120 and electrically connected to the first conductive collector 120. The second electrode 210 may be disposed on the second conductive collector 220 and electrically connected to the second conductive collector 220. The first electrode 110 and the second electrode 210 may be opposite to each other with the separator 310 interposed therebetween. The first electrode 110, the first conductive collector 120, the second electrode 210, the second conductive collector 220, and the separator 310 may be immersed in the first type electrolyte 410 and be encapsulated in the case 610. In other words, the case 610 may be filled by the first type electrolyte 410. The first type electrolyte 410 may surround the first electrode 110, the first conductive collector 120, the second electrode 210, the second conductive collector 220, and the separator 310.

With reference to FIG. 1, in some embodiments, the dimension D1 of the first electrode 110 and the dimension D2 of the first conductive collector 120 may be substantially the same. In some embodiments, the D1 of the first electrode 110 may be less than the dimension D2 of the first conductive collector 120. In some embodiments, the dimension D3 of the second electrode 210 and the dimension D4 of the second conductive collector 220 may be substantially the same. In some embodiments, the dimension D3 of the second electrode 210 may be less than the dimension D4 of the second conductive collector 220. In some embodiments, the dimension D5 of the separator 310 may be greater than the dimension D1 of the first electrode 110, the dimension D2 of the first conductive collector 120, dimension D3 of the second electrode 210, or the dimension D4 of the second conductive collector 220.

With reference to FIG. 1, in some embodiments, the first electrode 110 may include carbon nanotubes. In some embodiments, the first electrode 110 may include nitrogen atoms. In some embodiments, the first electrode 110 may include nitrogen atoms bonded to the carbon nanotubes. In some embodiments, the first electrode 110 may include nitrogen-doped carbon nanotubes. In some embodiments, the carbon nanotubes may be single walled nanotubes, multi-walled nanotubes, or a combination thereof. The carbon nanotubes can be thought of as a graphene ribbon (As shown in FIG. 2) rolled up into a tubular or cylindrical form.

With reference to FIG. 2, in some embodiments, the graphene ribbon comprises a plurality of sp²-hybridized carbon atoms 176 interconnected to form a one-atom thick sheet 178. In some embodiments, the graphene ribbon may have one or more ripples with the sheet 178. In some embodiments, the ripples may have an amplitude of at least less than about 25 nanometers (nm), preferably an amplitude of about one nanometer. In some embodiments, the amplitude of the one or more ripples may be different. That is, one ripple may have an amplitude of α, and another ripple may have an amplitude of δ, where α and δ may be different. In some embodiments, the graphene ribbon may have an electron mobility of at least about 5,000 cm²V⁻¹s⁻¹. In some embodiments, the electron mobility of the graphene ribbon may be at least about 10,000 cm²V⁻¹s⁻¹, or at least about 15,000 cm²V⁻¹s⁻¹. The high electron mobility of the graphene ribbon may support a charge transport capability.

The plurality of sp²-hybridized carbon atoms 176 may be interconnected in groups. In some embodiments, at least most of the sp²-hybridized carbon atoms in the graphene ribbon are interconnected in groups of six carbon atoms, with each group of six carbon atoms forming a substantially flat, regular hexagon 132. In some embodiments, at least about 95% of the sp²-hybridized carbon atoms 176 in the graphene ribbon may be interconnected in groups of six carbon atoms to form a plurality of regular hexagons 132. In some embodiments, at least about 99% of the sp²-hybridized carbon atoms 176 in the graphene ribbon may be interconnected to form a plurality of regular hexagons 132. In some embodiments, at least about 99.99% of the sp²-hybridized carbon atoms 176 in the graphene ribbon may be interconnected to form a plurality of regular hexagons 132.

In some embodiments, each side 134 of the regular hexagon 132 may have a carbon-carbon bond length from about 0.075 nm to about 0.35 nm. In some embodiments, each side 134 of the regular hexagon 132 has a carbon-carbon bond length from about 0.1 nm to about 0.2 nm or from about 0.13 nm to about 0.16 nm. In some embodiments, the graphene ribbon may include a large aromatic molecule including a plurality of sp²-hyrdrized carbon atoms 176.

In some embodiments, at least some of the sp²-hybridized carbon atoms 176 of the graphene ribbon may be interconnected in one or more groups of four, five, seven, eight and nine carbon atoms. The one or more groups of four, five, seven, eight and nine carbon atoms may be interconnected to one or more of the regular hexagon 132 groups of the sp²-hybridized carbon atoms 176 of the graphene ribbon. In some embodiments, at least some of the sp²-hybridized carbon atoms 176 of the graphene ribbon may be interconnected in groups of five carbon atoms, each group of five carbon atoms forming a substantially regular pentagon. In some embodiments, at least some of the sp²-hybridized carbon atoms 176 of the graphene ribbon may be interconnected in groups of seven carbon atoms, each group of seven carbon atoms forming a substantially regular heptagon.

With reference to FIG. 3, each of the single walled nanotubes may include a single graphene ribbon configured as a nanotube. In some embodiments, each of the single walled nanotubes may include a seamless hollow tube having a one-atom thick graphene wall and a chiral vector. In some embodiments, the chiral vector may include a pair of indices (n, m), which denote unit vectors along two directions of the crystal lattice of the graphene ribbon. In some embodiments, the single walled nanotubes may have chiral vectors where one of the following is true: a) n=m; and b) (n−m)/3 is an integer.

In some embodiments, the diameter of each of the single walled nanotubes may be between about 1 angstrom and about 200 nm, between about 3 nm and about 50 nm, or between about 10 nm and about 20 nm. In some embodiments, the length of each of the single walled nanotubes may be between about 1,000 nm and about 10 centimeters, between about 200 micrometers (μm) and about 1,000 μm, or between about 500 μm and about 600 μm. In some embodiments, each of the single walled nanotubes may include a first end 144 and a second end 146. The first end 144 and the second end 146 may be opposite to each other. In some embodiments, the first end 144 and the second end 146 may be opened or closed. In some embodiments, the first end 144 may be positioned on the first conductive collector 120.

With reference to FIG. 4, each multi-walled nanotube may include one or more graphene ribbons 132 (as shown in FIG. 2) rolled up around a single-walled nanotube core. These graphene ribbons 132 form multiple graphene walls 118. The multi-walled nanotubes may have a concentric cylinder structure (notated as 126 in FIG. 4) or a spiral structure (notated as 128 in FIG. 4). The interlayer distance 130 between graphene ribbons, which is the annular space between the inner and outer graphene walls 118 or the difference between the outer graphene ribbon diameter and inner graphene ribbon diameter, may be between about 1 angstrom and about 10 angstroms, or between about 2 angstroms and about 4 angstroms.

In some embodiments, the carbon nanotubes may be formed by various methods, including epitaxial growth, silicon carbide reduction, hydrazine reduction, sodium reduction of ethanol, chemical vapor deposition, gas-phase synthesis from high-temperature, high-pressure carbon monoxide, catalytic vapor deposition using carbon-containing feedstocks and metal catalyst particles, laser ablation, arc method, template synthesis, template-free synthesis, or self-assembly synthesis. In some embodiments, the carbon nanotubes may be formed by chemical vapor deposition or plasma-enhanced chemical vapor deposition. Chemical vapor deposition may be used to grow random carbon nanotubes, while plasma-enhanced chemical vapor deposition may produce aligned carbon nanotubes on various conductive or semi-conductive substrates. In some embodiments, nitrogen gas may be included during the plasma-enhanced chemical vapor deposition. In some embodiments, carbon nanotubes may be used as synthesized or modified with metals like Group VIB and VIIIB elements. These metals can act as catalysts or substrates for carbon nanotube synthesis.

For one example, a conductive substrate (e.g., nickel foil) may be coated with a thin layer of aluminum (e.g., 10 nm thickness), followed by a 3-nm iron film acting as a catalyst for carbon nanotube growth. The substrate may be then heated (at temperature about 750° C.) in a quartz tube furnace and exposed to a gas mixture containing about 48% argon, about 28% hydrogen, and about 24% ethylene for a period of time ranging from about 10 to about 20 minutes. This process may produce carbon nanotubes with a length that can be controlled by adjusting the gas pressure and exposure time.

For another example, a template-free synthesis may be provided to produce well-aligned carbon nanotubes in large quantities. In this example, iron (III) phthalocyanine may be pyrolyzed onto a quartz substrate at a temperature ranging from about 800° C. to about 1100° C. to form an aligned carbon nanotube film, followed by sputtering a metal layer (e.g., aluminum with the thickness ranging from 5 μm to 100 μm) onto the aligned carbon nanotube film. The carbon nanotubes can then be peeled off in a dry state using a double-sided conductive tape.

In both examples, the length of the carbon nanotubes may be controlled by the controlling pressure of the gaseous mixture and the period of time the heated substrate is exposed to the gaseous mixture. In both examples, the carbon nanotubes may be grown in a highly aligned manner, with the individual carbon nanotube arranged substantially parallel to each other and perpendicular to the substrate (e.g., the first conductive collector 120). In some embodiments, the spacing between carbon nanotubes may be between about 1 nm and about 1,000 nm or between about 10 nm and about 250 nm.

In some embodiments, plasma etching (or other forms of etching or milling) may be performed to remove the ends or tips of the carbon nanotubes and open up the interior of the carbon nanotubes, thereby effectively doubling the electrolyte-accessible surface area of the carbon nanotubes. In some embodiments, the etching may also purify the carbon nanotubes by eliminating residual catalysts.

In some embodiments, the etching may be an oxygen plasma etching. The oxygen plasma etching may substantially remove any surface contamination and/or amorphous carbon on the carbon nanotubes. The oxygen plasma etching may be performed by a radio frequency generator operating at 250 kHz, 30 W and 0.62 Torr for 20 minutes. The oxygen plasma etching may increase the spacing between carbon nanotubes.

With reference back to FIG. 1, the first electrode 110 may be disposed on the first conductive collector 120. In some embodiments, the carbon nanotubes of the first electrode 110 may be substantially perpendicular to the first conductive collector 120. In some embodiments, the first conductive collector 120 may be any highly conductive and/or superconductive material. Examples may include, without limitation, conductive metal (e.g., copper, aluminum, nickel, and stainless steel) foil, conductive metal mesh, electrically conductive polymers, electrically conductive polymer composites, graphite, superconductive ceramics, and the like. In some embodiments, the first conductive collector 120 may be porous or non-porous. In some embodiments, the first conductive collector 120 may be nickel foil. In some embodiments, the thickness of the first conductive collector 120 may be sufficient to provide current collection to the first electrode 110. In some embodiments, the thickness of the first conductive collector 120 may be between about 10 μm and about 75 μm.

With reference to FIG. 1, the second electrode 210 may include graphene. In some embodiments, the second electrode 210 may include nitrogen atoms. In some embodiments, the second electrode 210 may include nitrogen atoms bonded to the graphene. In some embodiments, the second electrode 210 may include nitrogen-doped graphene. In some embodiments, the second electrode 210 may include vanadium oxide (e.g., V₂O₅). It should be noted that in the present disclosure, graphene and graphene sheets may be used interchangeably.

In some embodiments, the graphene of the second electrode 210 may be formed by reduction of graphene oxide. The graphene oxide may be formed by exfoliation of graphite oxide. The graphite oxide may be formed by chemical oxidation of graphite using any suitable known oxidizing agents.

In some embodiments, the purified graphite oxide may be exfoliated to form graphene oxide by ultrasonication or mechanical shear for liquid dispersions. In some embodiments, rapid thermal treatment of the mostly dry graphite oxide leads to partial or complete exfoliation due to volatilization of the bound oxygen groups (epoxies, carboxyl, hydroxyl) and any incorporated species such as water, other solvents, residual acids or deliberately incorporated species.

In some embodiments, the purified exfoliated graphite oxide (in the form of graphene oxide) may be then subjected to reduction. The reduction may be a chemical reduction which involves adding a reducing agent to the graphene oxide to convert it to reduced graphene oxide or graphene. In some embodiments, the purified exfoliated graphite oxide may be dispersed in water and be then subjected to reduction. In some embodiments, the concentration of the graphene oxide (i.e., the purified exfoliated graphite oxide) dispersed in water may be less than 0.05 wt. %.

In some embodiments, the reducing agents may include inorganic reducing agents such as hydrazine or sodium borohydride and organic reducing agents such as hydroquinone, dimethylhydrazine or N,N′-diethylhydroxylamine. In some embodiments, the reducing agent may be hydrazine. When the reducing agent is hydrazine, it may be added in an amount of 1.0 to 7.0 grams of 35% hydrazine per gram of graphite oxide, 1.5 to 5.0 grams of 35% hydrazine per gram of graphite oxide, or 1.5 to 2.5 grams of 35% hydrazine per gram of graphite oxide. In some embodiments, the reducing agents may include a wide range of chemicals in both liquid and gas phase, such as ascorbic acid, sulfur-based reducing agents (e.g. sodium sulphite, sodium bisulfite, sodium thiosulphate, sodium sulfide, thionyl chloride, sulfur dioxide), dipotassium hydrogen phosphate, oxalates, hydroxides, hydroquinone, indole, saccharides, iodides, proteins, metal hydrides, hydrogen, carbon monoxide, urea and ammonia. In some embodiments, graphene oxide can also be reduced by heat and light.

In some embodiments, the pH during the reduction of the graphene oxide may be greater than 6 or between 9 and 11. The pH during the reduction of the graphene oxide may be adjusted by adding a base. In some embodiments, the base may include ammonia, sodium hydroxide, potassium hydroxide or water soluble organic bases such as methylamine ethanolamine, dimethylamine and trimethylamine. In some embodiments, the base may be a volatile base such as ammonia which can be removed after the graphene are processed into solid films or composites. When the base is ammonia, it may be added in an amount of 7 to 20 grams of 28% ammonia per gram of graphite oxide, 8 to 16 grams of 28% ammonia per gram of graphite oxide, or 10 to 13 grams of 28% ammonia per gram of graphite oxide.

In some embodiments, the graphene may be formed on the second conductive collector 220 by drop-casting from a dilute graphene dispersion, evaporation, coating, precipitation, spraying techniques such as air-brushing, or other applicable techniques.

In some embodiments, a thermal treatment such as annealing may be performed to improve the stiffness and strength of the graphene of the second electrode 210. In some embodiments, the process temperature of the thermal treatment may be about 220° C. The enhancement of mechanical properties may be attributed to the better ordering of graphene stacks brought about by thermal treatment, which results in enhanced inter-layer contact and interactions of the graphene sheets.

In some embodiments, the graphene may be dispersed in water or a solvent with binders to form a mixture. The weight ratio of the graphene to the binders may be between 25:75 and 99:1 or between 90:10 and 98:2. In some embodiments, the binders may include cellulosic materials, rubbers, and fluorinated resins. In some embodiments, the graphene may be dispersed in water or a solvent with binders and spacers to form the mixture. In some embodiments, the graphene may be dispersed in water or a solvent with spacers to form the mixture. The spacers may prevent or reduce the re-stacking of graphene sheets. The mixture may then be dried on the second conductive collector 220. In some embodiments, the graphene and the spacers may be co-precipitated on the second conductive collector 220. In some embodiments, the co-precipitation of the graphene and the spacers may be induced by addition of salts, changes in pH or concentration.

In some embodiments, the spacers may include surface modifications to the graphene sheets, such as surface deformations or attached polymers or particles. In some embodiments, the spacers may include polymers incorporated between the graphene sheets. In some embodiments, the polymers may be electrically conductive so as to further improve the electrical conductivity of the second electrode 210.

In some embodiments, the spacers may include particles of mostly chemically inert material such as carbon black, activated carbon, carbon nanotubes, carbon nano-onions, carbon nanofibers and other carbon allotropes or forms of carbon. In some embodiments, the spacers may include inert particles including oxides (e.g., alumina, zirconia, or silica) and non-oxides (silicon, carbides, or nitrides).

In some embodiments, the spacers may include molecules that will remain between the graphene sheets during operation of the second electrode 210. For example, large organic salts can be sterically locked in place by the graphene re-agglomeration but prevent restacking and maintain high accessible surface area by other electrolytes, including other, more mobile ionic liquids. Spacer molecules can include binders, polyionic liquid polymers, ionomers and ionic liquids amongst others.

In some embodiments, the spacers may be incorporated with the graphene by reduction of dispersions of graphene oxide in the presence of the spacers. For example, the reduction of the graphene oxide in the presence of cationic poly(ethyleneimine) may result in water-soluble PEI-modified graphene sheets. For another example, the reduction of graphene oxide in a dispersion with carbon black formed composites with the carbon black spacing apart the basal surfaces of the graphene.

An illustrative example for forming the graphene of the second electrode 210 may be as follows. Graphite oxide may be synthesized from graphite by applying the Hummers method with an additional dialysis step used to purify the product. As-synthesized graphite oxide was suspended in water to give a brown dispersion, which may be subjected to dialysis to completely remove residual salts and acids. As-purified graphite oxide suspensions may be then dispersed in water to create a 0.05 wt. % dispersion. Exfoliation of graphite oxide to graphene oxide may be achieved by ultrasonication of the dispersion using for 30 min. The obtained brown dispersion may be then subjected to 30 min of centrifugation at 3000 RPM to remove any unexfoliated graphite oxide (usually present in a very small amount). In order to achieve chemical conversion of graphene oxide to graphene, the resulting homogeneous dispersion (5.0 mL) was mixed with 5.0 mL of water, 5.0 μL of hydrazine solution (35 wt. % in water) and 35.0 μL of ammonia solution (28 wt. % in water) in a 20 mL-glass vial. After being vigorously shaken or stirred for a few minutes, the vial was put in a water bath at 95° C. for 1 hour. The excess hydrazine in the reaction mixture may be removed by dialysis against a dilute ammonia solution.

In some embodiments, the second electrode 210 may be a layered structure. For example, the second electrode 210 may include a bottom layer including the graphene (or nitrogen-doped graphene) and a top layer disposed on the bottom layer and including vanadium oxide. The bottom layer of the second electrode 210 may be disposed on the second conductive collector 220. In some embodiments, the top layer including vanadium oxide may be formed by, for example, electrochemical deposition, chemical vapor deposition, physical vapor deposition, sputtering, or reactive deposition. In some embodiments, the thickness of the top layer including the vanadium oxide may be between about 1 nm and about 100 nm. In some embodiments, the vanadium oxide may be dispersed between spaces of the graphene sheets.

With reference to FIG. 1, the second electrode 210 may be disposed on the second conductive collector 220. In some embodiments, the second conductive collector 220 and the first conductive collector 120 may be formed of the same material. In some embodiments, the second conductive collector 220 and the first conductive collector 120 may be formed of different materials. In some embodiments, the second conductive collector 220 may be any highly conductive and/or superconductive materials. Examples may include, without limitation, conductive metal (e.g., copper, aluminum, nickel, and stainless steel) foil, conductive metal mesh, electrically conductive polymers, electrically conductive polymer composites, graphite, superconductive ceramics, and the like. In some embodiments, the second conductive collector 220 may be porous or non-porous. In some embodiments, the second conductive collector 220 may be nickel foil. In some embodiments, the thickness of the second conductive collector 220 may be sufficient to provide current collection to the second electrode 210. In some embodiments, the thickness of the second conductive collector 220 may be between about 10 μm and about 75 μm.

With reference to FIG. 1, the separator 310 may be disposed between the first electrode 110 and the second electrode 210. In some embodiments, the separator 310 may include a thin, non-conductive, porous material. The porosity of the separator 310 may be between about 40% and about 87% or between about 65% and about 85%. The thickness of the separator 310 may be between about 25 μm and about 75 μm.

With reference to FIG. 1, the first type electrolyte 410 may be in liquid type. The first electrode 110, the first conductive collector 120, the second electrode 210, the second conductive collector 220, the separator 310 may be immersed in the first type electrolyte 410. In some embodiments, the first type electrolyte 410 may include aqueous electrolytes, organic electrolytes, or ionic liquids. In some embodiments, the aqueous electrolytes may include sulfuric acid, potassium hydroxide, sodium sulfate, or sodium chloride. In some embodiments, the organic electrolytes may include tetraethylammonium tetrafluoroborate or propylene carbonate with lithium salt. In some embodiments, the ionic liquids may include 1-butyl-3-methylimidazolium tetrafluoroborate or 1-ethyl-3-methylimidazolium ethylsulfate.

With reference to FIG. 1, the first type electrolyte 410, the first electrode 110, the first conductive collector 120, the second electrode 210, the second conductive collector 220, and the separator 310 may be encapsulated in the case 610. In some embodiments, the case 610 may be formed of, for example, aluminum, titanium, stainless steel, or polymeric materials such as polypropylene or polyvinyl chloride.

By using carbon nanotubes for the first electrode 110, the dispersion may become more uniform, and charge transfer may be enhanced. Additionally, the graphene in the second electrode 210 may provide a larger surface area for the distribution of vanadium oxide, which can further increase the conductivity of the second electrode. As a result, the overall performance of the capacitor structure 100A may improve.

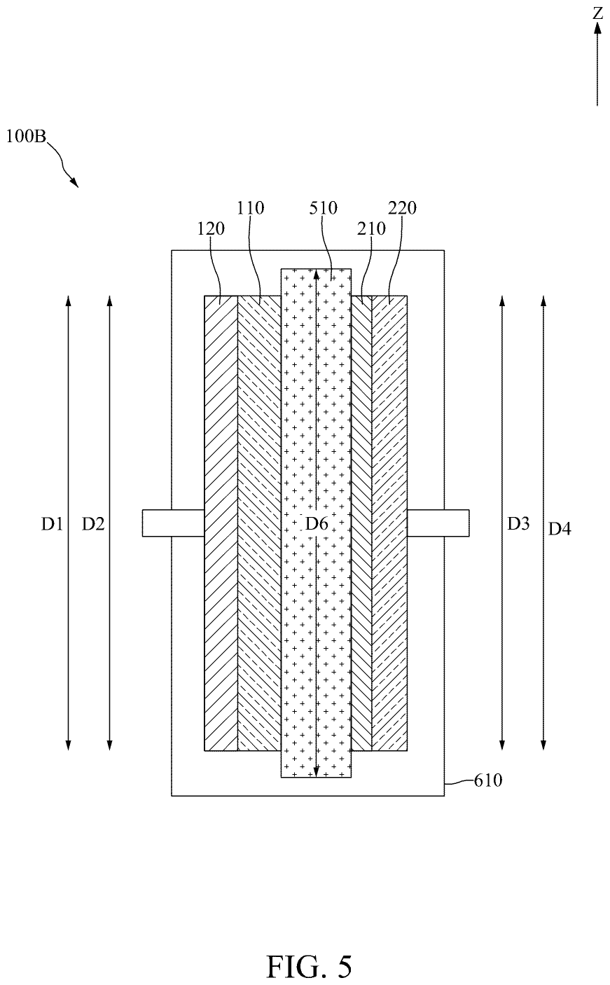

FIG. 5 illustrates, in a schematic cross-sectional view diagram, a capacitor structure 100B in accordance with another embodiment of the present disclosure.

With reference to FIG. 5, the capacitor structure 100B may include a first electrode 110, a second electrode 210, a first conductive collector 120, a second conductive collector 220, a second type electrolyte 510, and a case 610. The first electrode 110 may be disposed on the first conductive collector 120 and electrically connected to the first conductive collector 120. The second electrode 210 may be disposed on the second conductive collector 220 and electrically connected to the second conductive collector 220. The first electrode 110 and the second electrode 210 may be opposite to each other with the second type electrolyte 510 interposed therebetween. The first electrode 110 and the second electrode 210 may both contact the second type electrolyte 510. The first electrode 110, the first conductive collector 120, the second electrode 210, the second conductive collector 220, and the second type electrolyte 510 may be encapsulated in the case 610.

With reference to FIG. 5, in some embodiments, the dimension D1 of the first electrode 110 and the dimension D2 of the first conductive collector 120 may be substantially the same. In some embodiments, the dimension D1 of the first electrode 110 may be less than the dimension D2 of the first conductive collector 120. In some embodiments, the dimension D3 of the second electrode 210 and the dimension D4 of the second conductive collector 220 may be substantially the same. In some embodiments, the dimension D3 of the second electrode 210 may be less than the dimension D4 of the second conductive collector 220. In some embodiments, the dimension D6 of the second type electrolyte 510 may be greater than the dimension D1 of the first electrode 110, the dimension D2 of the first conductive collector 120, dimension D3 of the second electrode 210, or the dimension D4 of the second conductive collector 220.

With reference to FIG. 5, the first electrode 110, the first conductive collector 120, the second electrode 210, the second conductive collector 220, and the case 610 may be formed of the same or similar materials and procedures as illustrated in FIG. 1, and descriptions thereof are not repeated herein.

With reference to FIG. 5, the second type electrolyte 510 may be a solid-state electrolyte. In some embodiments, the second type electrolyte 510 may include an ion-conducting polymer or a combination of an ion-conductive polymer and an ionic compound. In some embodiments, the thickness of the second type electrolyte 510 may be between about 0.5 μm and about 50 μm. In some embodiments, the ion-conducting polymer may include polyether ether ketone, sulfonated polyether ether ketone, polyphenylene vinylene, poly(ether ketone ketone), polyethylene oxide, Nafion, polyvinyl alcohol, polytetrafluoroethylene, polypyrrole, polyvinylidene fluoride, polyethylenedioxythiophene, polyaniline, or a combination thereof. In some embodiments, the ionic compound may include lithium hydroxide, lithium nitrate, lithium trifluoromethyl sulfur trioxide, or a combination thereof. In some embodiments, the ionic compound may include lithium salts, sodium salts, potassium salts, magnesium salts, ammonium salts, imidazolium-based salts, and/or pyridinium-based salts. In some embodiments, the lithium salts may include lithium hexafluorophosphate or lithium perchlorate. In some embodiments, the potassium salts may include potassium hydroxide. In some embodiments, the sodium salts may include sodium sulfate or sodium nitrate. In some embodiments, the ammonium salts may include ammonium perchlorate. In some embodiments, the magnesium salts may include magnesium perchlorate. In some embodiments, the imidazolium-based salts may include 1-ethyl-3-methylimidazolium tetrafluoroborate or 1-butyl-3-methylimidazolium tetrafluoroborate. In some embodiments, the pyridinium-based salts may include 1-ethyl-3-methylimidazolium bis(trifluoromethanesulfonyl)imide or 1-butyl-3-methylimidazolium bis(trifluoromethanesulfonyl)imide.

By employing the second type electrolyte 510 the safety, mechanical stability, operating voltage window, and potential for miniaturization of the capacitor structure 100B may be improved and the self-discharge of the capacitor structure 100B may be reduced.

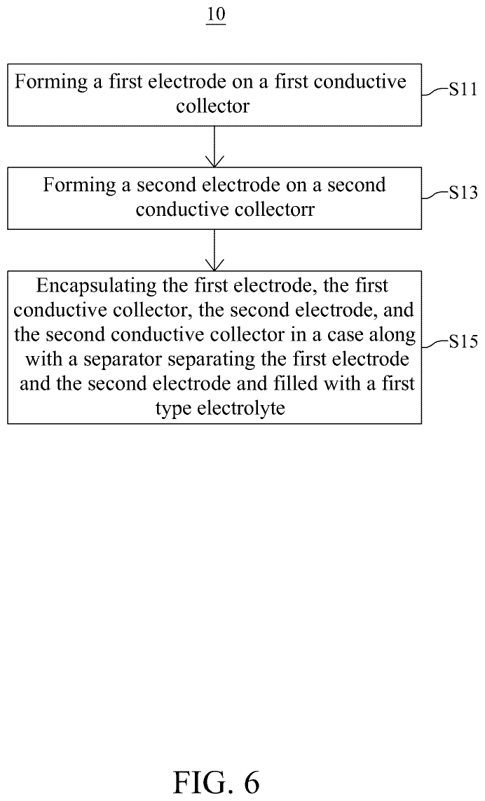

FIG. 6 illustrates, in a flowchart diagram form, a method 10 for fabricating a capacitor structure 100A in accordance with one embodiment of the present disclosure.

With reference to FIG. 6, at step S11, a first electrode 110 may be formed on a first conductive collector 120. In some embodiments, the first electrode 110 may include carbon nanotubes and can be formed using methods such as epitaxial growth, silicon carbide reduction, hydrazine reduction, sodium reduction of ethanol, chemical vapor deposition, gas-phase synthesis from high-temperature, high-pressure carbon monoxide, catalytic vapor deposition with carbon-containing feedstocks and metal catalyst particles, laser ablation, the arc method, template synthesis, template-free synthesis, or self-assembly synthesis. In some cases, the first electrode 110 may be grown directly on the first conductive collector 120 using a catalyst, or it may be formed separately and then transferred to the collector.

With reference to FIG. 6, at step S13, a second electrode 210 may be formed on a second conductive collector 220. In some embodiments, the second electrode 210 may include graphene and vanadium oxide. The graphene may be formed by reduction of graphene oxide. In some embodiments, the graphene may be formed on the second conductive collector 220 by drop-casting from a dilute graphene dispersion, evaporation, coating, precipitation, spraying techniques such as air-brushing, or other applicable techniques. The vanadium oxide may be formed by, for example, electrochemical deposition, chemical vapor deposition, physical vapor deposition, sputtering, or reactive deposition.

With reference to FIG. 6, at step S15, the first electrode 110, the first conductive collector 120, the second electrode 210, and the second conductive collector 220 may be encapsulated in a case 610 along with a separator 310 separating the first electrode 110 and the second electrode 210 and filled with a first type electrolyte 410.

The first electrode 110, the first conductive collector 120, the second electrode 210, the second conductive collector 220, the separator 310, the first type electrolyte 410, and the case 610 together configure a capacitor structure 100A.

One aspect of the present disclosure provides a capacitor structure including a first electrode including carbon nanotubes; a second electrode including graphene and vanadium oxide; a separator separating the first electrode and the second electrode; and a first type electrolyte surrounding the first electrode, the second electrode, and the separator.

Another aspect of the present disclosure provides a capacitor structure including a first electrode including carbon nanotubes; a second electrode including graphene and vanadium oxide; and a second type electrolyte positioned between the first electrode and the second electrode; wherein the second type electrolyte is a solid-state electrolyte. Both the first electrode and the second electrode contact the second type electrolyte.

Another aspect of the present disclosure provides a method for fabricating a capacitor structure including forming a first electrode on the first conductive collector; forming a second electrode on the second conductive collector; and encapsulating the first electrode, the first conductive collector, the second electrode, and the second conductive collector in a case along with a separator separating the first electrode and the second electrode, and a first type electrolyte filling the case; wherein the first electrode includes carbon nanotubes. The second electrode includes graphene and vanadium oxide.

Due to the design of the capacitor structure of the present disclosure, dispersion becomes more uniform, and charge transfer may be enhanced by using carbon nanotubes for the first electrode 110. Additionally, the graphene in the second electrode 210 may provide a larger surface area for distributing vanadium oxide, further increasing the conductivity of the second electrode 210. Consequently, the overall performance of the capacitor structure 100A may improve. Furthermore, employing the second type electrolyte 510 may enhance the safety, mechanical stability, and operating voltage window of the capacitor structure 100B, while also reducing self-discharge.

Although the present disclosure and its advantages have been described in detail, it should be understood that various changes, substitutions and alterations can be made herein without departing from the spirit and scope of the disclosure as defined by the appended claims. For example, many of the processes discussed above can be implemented in different methodologies and replaced by other processes, or a combination thereof.

Moreover, the scope of the present application is not intended to be limited to the particular embodiments of the process, machine, manufacture, composition of matter, means, methods and steps described in the specification. As one of ordinary skill in the art will readily appreciate from the disclosure of the present disclosure, processes, machines, manufacture, compositions of matter, means, methods, or steps, presently existing or later to be developed, that perform substantially the same function or achieve substantially the same result as the corresponding embodiments described herein may be utilized according to the present disclosure. Accordingly, the appended claims are intended to include within their scope such processes, machines, manufacture, compositions of matter, means, methods, and steps.

What is claimed is:

1. A capacitor structure, comprising:
a first electrode comprising carbon nanotubes;
a second electrode comprising graphene and vanadium oxide;
a separator separating the first electrode and the second electrode; and
a first type electrolyte surrounding the first electrode, the second electrode, and the separator.

2. The capacitor structure of claim 1, further comprising a first conductive collector, wherein the first electrode is positioned on the first conductive collector and electrically connected to the first conductive collector.

3. The capacitor structure of claim 2, further comprising a second conductive collector, wherein the second electrode is positioned on the second conductive collector and electrically connected to the second conductive collector.

4. The capacitor structure of claim 3, wherein a dimension of the first electrode is equal to or less than a dimension of the first conductive collector.

5. The capacitor structure of claim 3, wherein a dimension of the second electrode is equal to or less than a dimension of the second conductive collector.

6. The capacitor structure of claim 3, wherein a dimension of the separator is greater than a dimension of the first electrode.

7. The capacitor structure of claim 6, wherein the carbon nanotubes of the first electrode is doped with nitrogen.

8. The capacitor structure of claim 6, wherein the graphene of the second electrode is doped with nitrogen.

9. The capacitor structure of claim 6, wherein the second electrode is a layered structure comprising a bottom layer comprising the graphene and a top layer comprising the vanadium oxide and positioned on the bottom layer.

10. The capacitor structure of claim 9, wherein a thickness of the top layer is between about 1 nm and about 100 nm.

11. The capacitor structure of claim 6, wherein a thickness of the separator is between about 25 μm and about 75 μm.

12. The capacitor structure of claim 6, wherein a porosity of the separator is between about 40% and about 87%.

13. The capacitor structure of claim 6, wherein the first type electrolyte comprises aqueous electrolytes, organic electrolytes, or ionic liquids.

14. The capacitor structure of claim 6, wherein the first conductive collector comprises metal foil.

15. The capacitor structure of claim 6, further comprising a case encapsulating the first electrode, the first conductive collector, the second electrode, the second conductive collector, the separator, and the first type electrolyte.

16. A capacitor structure, comprising:
a first electrode comprising carbon nanotubes;
a second electrode comprising graphene and vanadium oxide; and
a second type electrolyte positioned between the first electrode and the second electrode;
wherein the second type electrolyte is a solid-state electrolyte;
wherein both the first electrode and the second electrode contact the second type electrolyte.

17. The capacitor structure of claim 16, further comprising a first conductive collector, wherein the first electrode is positioned on the first conductive collector and electrically connected to the first conductive collector.

18. The capacitor structure of claim 17, further comprising a second conductive collector, wherein the second electrode is positioned on the second conductive collector and electrically connected to the second conductive collector.

19. The capacitor structure of claim 18, wherein a dimension of the first electrode is equal to or less than a dimension of the first conductive collector.

20. The capacitor structure of claim 18, wherein a dimension of the second electrode is equal to or less than a dimension of the second conductive collector.
